(19) United States
(12) Patent Application Publication
(10) Pub. No.: US 2011/0154401 A1
(43) Pub. Date: Jun. 23, 2011

(54) Systems and Methods to Generate an Electronic Program Guide

(75) Inventors: Lee M. Chow, Naperville, IL (US); David Piepenbrink, Chicago, IL (US); Stephen Rys, Austin, TX (US); James T. Sofos, Aurora, IL (US)

(73) Assignee: AT&T INTELLECTUAL PROPERTY I, L.P., Reno, NV (US)

(21) Appl. No.: 12/640,317

(22) Filed: Dec. 17, 2009

(51) Int. Cl. H04N 5/445; H04N 7/173

(52) U.S. Cl. 725/49; 725/100; 725/54; 725/58

(57) ABSTRACT

Systems and methods to generate an electronic program guide (EPG) are provided. A particular method includes accessing, at a set-top box device, data descriptive of over-the-air (OTA) television content items. The OTA television content items are available to the set-top box device via one or more television broadcast transmissions. The method includes accessing, at the set-top box device, data descriptive of on-demand media content items that are accessible by the set-top box device via a public network. The method includes generating an EPG that concurrently displays information related to the data descriptive of on-demand media content items and the data descriptive of the OTA television content items. The method also includes sending the EPG to a display device associated with the set-top box device.

### FIELD OF THE DISCLOSURE

The present disclosure is generally related to generating an electronic program guide.

### BACKGROUND

A public internet backbone allows service providers to provide access to a public network to customers. Many service providers provide video services to customers in addition to providing access to the public network. Video services may utilize a private network infrastructure (e.g., a cable network, satellite network, or internet protocol television network) to deliver television content and on-demand media content to a destination address (e.g., a residence) of a customer. Establishing and maintaining the private network infrastructure to deliver the television content and on-demand media content may require a large investment.

### BRIEF DESCRIPTION OF THE DRAWINGS

FIG. 1 is a block diagram of a particular embodiment of a system to generate an electronic program guide (EPG).

FIG. 2 is a representation of a particular embodiment of an EPG displayed on a display device.

FIG. 3 is a flow diagram of a particular method to generate an EPG.

FIG. 4 is a flow diagram of a particular embodiment of a method for using a generated EPG when a set-top box device receives user input selecting an on-demand media content item from the EPG for display.

FIG. 5 is a flow diagram of a particular embodiment of a method for using a generated EPG when a set-top box device receives user input selecting an over-the-air (OTA) television content item from the EPG for display.

FIG. 6 is a flow diagram of a particular embodiment of a method for using a generated EPG when a set-top box device receives user input selecting an item from an EPG for recording.

FIG. 7 is a block diagram of an illustrative embodiment of a general computer system.

### DETAILED DESCRIPTION

A service provider may use existing infrastructure to deliver over-the-air (OTA) television content items and on-demand media content items to customers. For example, the service provider may use an existing public internet backbone to deliver on-demand media content items to customer premises equipment (e.g., set-top box devices). Each set-top box device may receive local channels as over-the-air (OTA) broadcasts through an antenna coupled to the set-top box device. An authenticated and authorized set-top box device may solicit on-demand media content from a service provider network. The service provider network may provide solicited on-demand media content items via the public network. The set-top box device may generate an electronic program guide (EPG) that combines media content available as OTA television content items with media content available as on-demand media content items from the service provider network so that each customer has a listing of available media content items and information indicating when the media content items are scheduled to be shown.

In a particular embodiment, a set-top box device includes a memory device and the set-top box device includes a network interface configured to receive on-demand media content items via a public network. The set-top box device includes one or more video tuners configured to receive OTA television content items via one or more television broadcast transmissions. The set-top box device includes an EPG module configured to generate an EPG that concurrently displays information descriptive of the on-demand media content items that are available via the public network and information descriptive of the OTA television content items available via the one or more television broadcast transmissions. The set-top box device also includes a video recording module configured to selectively record the OTA television content items to the memory device.

In a particular embodiment, a method includes accessing, at a set-top box device, data descriptive of over-the-air (OTA) television content items. The OTA television content items are available to the set-top box device via one or more television broadcast transmissions. The method further includes accessing, at the set-top box device, data descriptive of on-demand media content items that are accessible by the set-top box device via a public network. The method includes generating an electronic program guide (EPG). The EPG concurrently displays information related to the data descriptive of on-demand media content items and the data descriptive of the OTA television content items. The method also includes sending the EPG to a display device associated with the set-top box device.

In a particular embodiment, a set-top box device includes at least one processor and at least one memory accessible to the at least one processor. The at least one memory includes instructions executable by the at least one processor to determine one or more available OTA channels. The at least one memory includes instructions executable by the at least one processor to access data descriptive of OTA channel content items for the one or more available OTA channels for a particular time period. The at least one memory includes instructions executable by the at least one processor to access data descriptive of on-demand media content items that are accessible via a public network. The at least one memory includes instructions executable by the at least one processor to generate an EPG. The EPG concurrently displays the data descriptive of the on-demand media content items and the data descriptive of the OTA television content items for the particular time period.

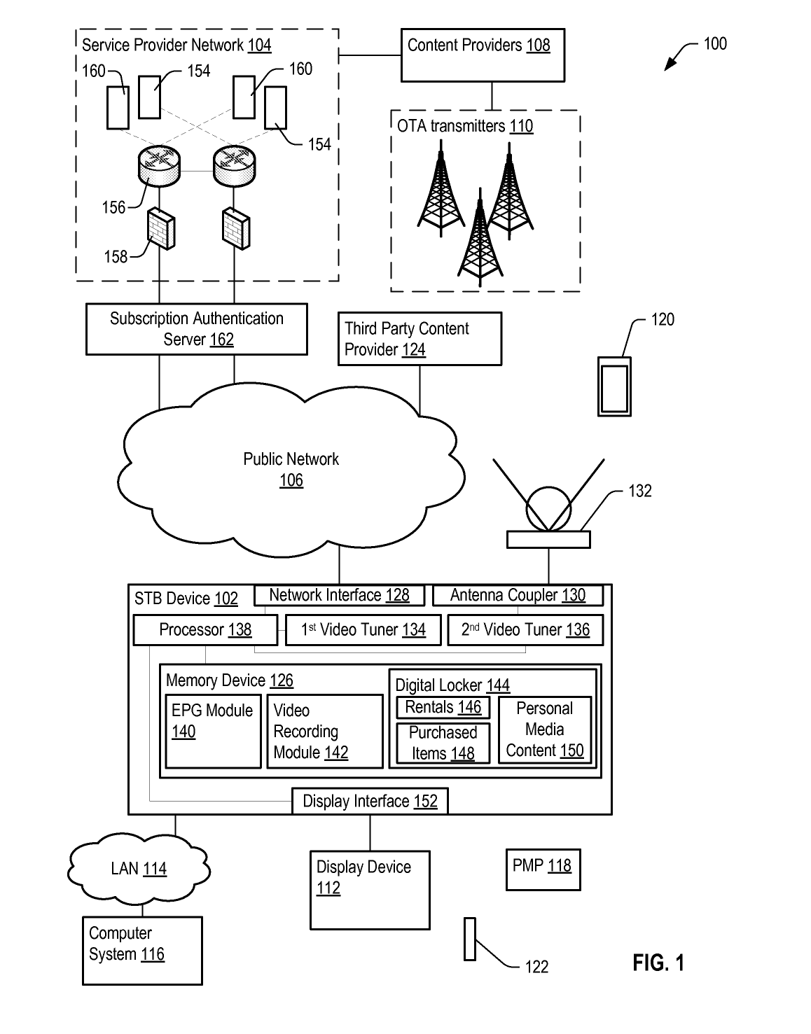

Referring to FIG. 1, a block diagram of a particular embodiment of a system to generate an EPG is designated generally 100. The system 100 may include a set-top box device 102 in communication with a service provider network 104 via a public network 106. The service provider network 104 may be a portion of a system that provides access to the public network 106 for customers. The service provider network 104 may be part of a system maintained by a service provider such as an internet service provider, a cable television system provider, an internet protocol television system provider, a satellite television system provider, other service provider, or combinations thereof. The service provider may also have one or more additional service provider networks 104 to accommodate service to customers in various regions, to accommodate customers in regions with off-line equipment, or both. The service provider network 104 may provide television content and other media content provided by one or more content providers 108 to customers. The public network 106 may be an internet protocol (IP) based network, such as the internet.

The set-top box device 102 may also receive broadcasts from one or more over-the-air (OTA) transmitters 110. The OTA transmitters 110 may include television content broadcast transmitters associated with local programming content available from one or more of the content providers 108.

The set-top box device 102 may be able to receive media content from the service provider network 104 and from the OTA transmitters 110. The set-top box device 102 may process the media content for display via a display device 112. The media content may also be sent from the set-top box device 102 to other devices 116-120 via the public network 106 or via a local area network (LAN) 114. The other devices 116-120 may include, but are not limited to, a computer system 116, a personal media player (PMP) 118, and a communication device 120 (e.g., a cellular telephone having internet access capabilities). The set-top box device 102 may receive user input from a remote control device 122 or from one or more of the other devices 116-120.

The set-top box device 102 may also be able to receive media content from other sources including media content from one or more third party content providers 124 via the public network 106; media content and personal media content via the public network 106 or via the LAN 114 from the computer system 116, the personal media player 118, and the communication device 120; and stored media content from a memory device 126 of the set-top box device 102. Examples of third party content providers 124 may include, but are not limited to, YouTube®, news feeds such as CNN Newsource®, and the iTunes Store®. The media content from the service provider network 104, from the OTA transmitters 110, and from the other sources may include, but is not limited to, television content, on-demand media content (e.g., video-on-demand, movies, music, and games), applications and services available via the public network 106 (e.g., YellowPages.com®, weather web sites, and web games) from one or more application servers 164, and personal media content (e.g., user generated video, photographs, slide shows, music, and other multimedia content). The on-demand media content may be available in a standard definition (SD) format, a high definition (HD) format, or both.

The set-top box device 102 may include a network interface 128 to receive media content via the public network 106 and the LAN 114. The set-top box device 102 may also include an antenna coupler 130 to couple to one or more antennas 132. The one or more antennas 132 may receive television broadcast transmissions from the OTA transmitters 110. The one or more antennas 132 may be an integral component of the set-top box device 102, may be an indoor antenna coupled by a coaxial cable or other connector to the set-top box device 102, may be an outdoor antenna coupled by a coaxial cable or other connector to the set-top box device 102, or may be combinations thereof.

The antenna coupler 130 may be in communication with one or more video tuners, such as a first video tuner 134 and a second video tuner 136. The one or more video tuners 134, 136 may include one or more Advanced Television Systems Committee (ATSC) tuners. In a particular embodiment, the first video tuner 134 may receive digitally broadcast transmissions and the second video tuner 136 may receive analog broadcast transmissions. The video tuners 134, 136 may allow for the reception of standard definition video content, high definition video content, analog video content, digital video content, or any combination thereof broadcast from the OTA transmitters 110 and in range of the one or more antennas 132 coupled to the antenna coupler 130 of the set-top box device 102.

The set-top box device 102 may also include a processor 138 configured to process media content received via the network interface 128 or from one of the video tuners 134, 136. For example, the processor 138 may process the media content for display at the display device 112. The processor 138 may also process the media content to send from the network interface 128 via the public network 106 or the LAN 114 to one of the other devices 116-120. For example, the network interface 128 may receive a request initiated by the communication device 120 to receive the EPG. The request may be passed from the network interface 128 to the processor 138. The processor 138 may use an EPG module 140 to generate the EPG. The processor 138 may send the EPG from the network interface 128 to the communication device 120. After the communication device 120 has received the EPG, the communication device 120 may send commands related to the content of the EPG to the network interface 128 of the set-top box device 102.

The memory device 126 may include the EPG module 140 to generate an EPG for display at the display device 112 or at one of the other devices 116-120 coupled to the set-top box device 102. In a particular embodiment, the EPG module 140 generates the EPG to concurrently display data descriptive of on-demand media content items that are available from the service provider network 104 via the public network 106 and data descriptive of OTA television content items available from the OTA transmitters 110 via the one or more television broadcast transmissions.

The memory device 126 may also include a video recording module 142. The video recording module 142 may digitally record user selected OTA television content items to a digital locker 144 of the memory device 126. The video recording module 142 may allow user selected OTA television content items to be recorded to a network digital video recorder coupled to, or otherwise accessible to, the set-top box device 102. The network digital video recorder may be coupled by wire or wirelessly to the set-top box device 102 or may be part of a service available from the service provider and accessed through the public network 106. The digital locker 144 may include rented media content 146, purchased media content 148, and personal media content 150. Particular rented media content items of the rented media content 146 may automatically be deleted after a certain time or after the particular rented media content items have been viewed. The personal media content 150 may include, but is not limited to, home videos and photographs.

Selected on-demand media content items may be streamed, progressively downloaded, or fully downloaded to the set-top box device 102. Progressively downloaded and fully downloaded on-demand media content items may be stored in the rented media content 146 of the digital locker 144. An on-demand media content item that is streamed, progressively downloaded, or fully downloaded to the set-top box device 102 is referred to as having been downloaded.

The processor 138 may allow the video recording module 142 to record an OTA television content item in the digital locker 144 of the memory device 126. The processor 138 may allow the video recording module 142 to record an on-demand media content item in the digital locker 144 of the memory device 126. The processor 138 may allow the video recording module 142 to simultaneously record a first OTA television content item and a first on-demand media content item in the digital locker 144 of the memory device 126. The processor 138 may allow an additional media content item to be sent to the display device 112 via a display interface 152. The processor 138 may allow media content stored in the digital locker 144 to be sent to one of the other devices 116-120 while media content is being sent to the display device 112 or while the video recording module 142 is in use to record one or more media content items in the digital locker 144 of the memory device 126.

The content providers 108 may provide subscription based content to one or more intake servers 154 of the service provider network 104. The subscription based content may include content provided by the service provider to customers on a subscription basis. Examples include television content traditionally associated with basic cable service. The content providers 108 may also provide premium media content via the one or more intake servers 154 of the service provider network 104. Examples of premium content may include premium channels traditionally available via cable television service providers on a premium content basis (e.g., HBO® and SHOWTIME®). The content providers 108 may also provide content provided by broadcast networks when the local affiliate of the broadcast network is not accessible to the set-top box device 102 through a broadcast from the OTA transmitters 110.

The service provider network 104 may include one or more routers 156 to route content received from the content providers 108 to one or more customers associated with the service provider. The service provider network 104 may also include one or more firewalls 158 to restrict access to the service provider network 104, to the one or more intake servers 154, and to one or more other servers associated with the service provider.

The service provider network 104 may include one or more EPG servers 160. The EPG servers 160 may provide data that describes the media content items provided by the service provider network 104 through the public network 106, including start times and end times for the media content items. The media content items may include subscription based content and on-demand media content. The EPG module 140 of the set-top box device 102 may modify the data from the EPG servers 160 to include data that describes the OTA television content items so that the EPG produced by the EPG module 140 concurrently displays the on-demand media content items available from the service provider network 104 and the OTA television content items available from the OTA transmitters 110. The data that describes the OTA television content items may be obtained via the public network 106 from web pages of the broadcast stations providing the broadcast transmissions, from news services that provide local television content, from other sources, or combinations thereof. The data may include a start time and an end time for the OTA television content items.

The EPG module 140 may also include other options for retrieving additional media content identified by the EPG produced by the EPG module 140. The other options may include, but are not limited to, providing access to a catalog of on-demand media content available from the service provider, providing access to content of the set-top box device 102 stored in the digital locker 144, providing access to a catalog of on-demand media content available from one or more third party content providers 124, and providing access to media content available from one or more devices 116-120 coupled to the set-top box device 102 by the LAN 114 or by the public network 106. The EPG module 140 may provide the generated EPG to a device (e.g., the display device 112, the computer system 116, the PMP 118, or the communication device 120) associated with a received request for the EPG.

A subscription authentication server 162 may be associated with the service provider. The subscription authentication server 162 may authenticate a particular set-top box device, such as the set-top box device 102, to verify that the particular set-top box device is authorized to access particular media content provided by the service provider network 104.

In a particular embodiment, the set-top box device 102 may receive user input related to a particular media content item presented in the EPG provided by the EPG module 140. When the particular media content item is a subscription based content item from the service provider network 104, the set-top box device 102 may send an authentication message to the subscription authentication server 162 to authenticate that the set-top box device 102 is authorized to access the particular media content item. Access may be denied when the user does not have authorization to the particular media content item. When the user does have authorization to the particular media content item, the system 100 may allow retrieval of the particular media content item.

When the particular media content item is an OTA television content item available via the OTA transmitters 110, the set-top box device 102 may determine whether a broadcast time for the particular content item has been reached. When the broadcast time for the content item has been reached, or been substantially reached (e.g., within two minutes of a start time for the particular media content item) one of the video tuners 134, 136 may be tuned to a channel associated with the particular media content item.

When the broadcast time associated with the particular media content item has not been substantially reached, the set-top box device 102 may implement a search to determine whether the selected content item is available as an on-demand content item via the third party content provider 124 or via the service provider network 104. When the particular media content item is available as an on-demand content item, the set-top box device 102 may send a notification message to a device 112, 116, 118, 120 associated with the user input to notify the user that the particular media content item is available as on-demand media content. The notification message may provide an option to retrieve the on-demand media content item via the public network 106. When a user selects to receive the particular media content item as the on-demand media content item via the public network 106, the set-top box device 102 may send a request to retrieve the particular media content item from a source that has the on-demand media content item (i.e., the service provider network 104 or the third party content provider 124).

In a particular embodiment, the user may use the EPG provided by the EPG module 140 to schedule a particular media content item for recording via the video recording module 142. The set-top box device 102 may check to see if the media content corresponding to the particular media content item is available immediately as on-demand media content. When the particular media content item is available immediately as on-demand media content, the set-top box device 102 may notify the user of the availability and provide an option to store the on-demand media content in the memory device 126 of the set-top box device 102, immediately show the particular media content item, or both. When the particular media content item is not available immediately as on-demand media content, or when the user opts not to retrieve the immediately available on-demand media content, the processor 138 of the set-top box device 102 may execute instructions of the video recording module 142 to schedule a recording event to record the particular media content item to the memory device 126. The recording event may include a recording start time and a recording stop time. When the particular media content item is an OTA television content item, the set-top box device 102 may tune one or more of the video tuners 134, 136 to a broadcast channel associated with the OTA television content item at the start time and store the OTA television content item in the memory device 126.

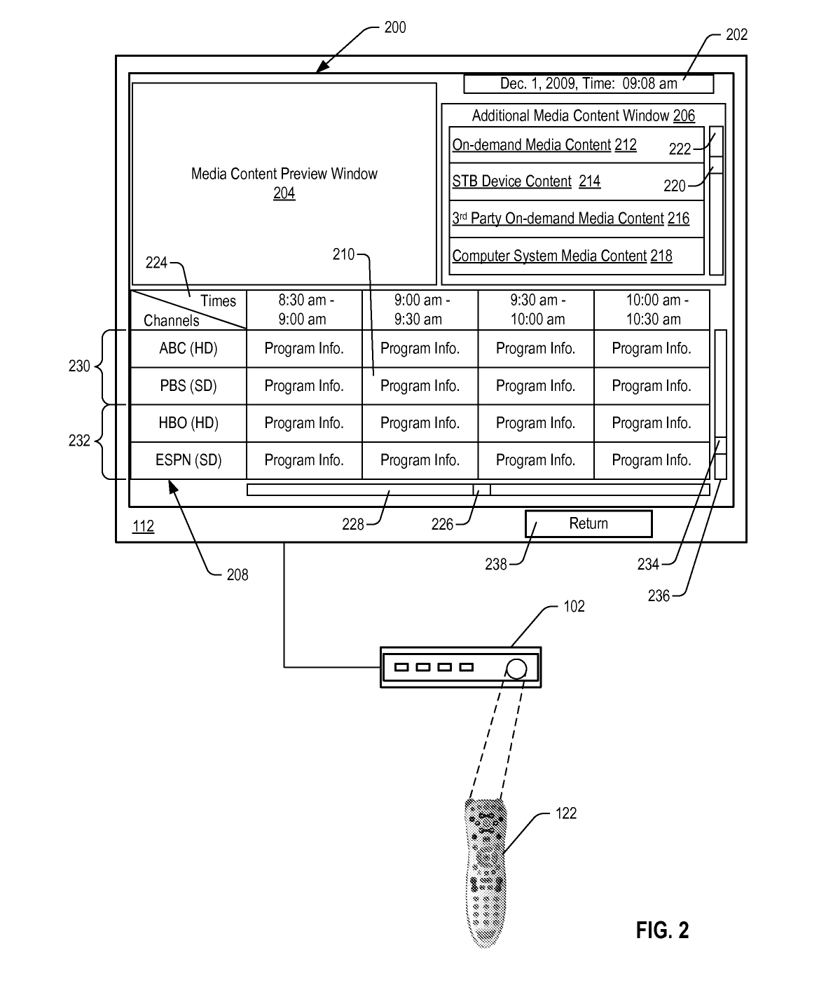

Referring to FIG. 2, a representation of a particular embodiment of an EPG displayed on the display device 112 is designated generally as 200. The display device 112 may be coupled to the set-top box device 102. The set-top box device 102 in FIG. 2 may be similar to or the same as the set-top box 102 shown in FIG. 1. A user may send input to the set-top box device 102 using the remote control device 122. The EPG 200 may include a date and time window 202, a media content preview window 204, an additional media content window 206, and an EPG table 208. The data and time window 202 may display the current date and time.

The media content preview window 204 may display content that is currently presented on a channel corresponding to an entry 210 of the EPG table 208 that is highlighted when a time range for the entry 210 includes the current time. When the time range corresponding to the entry 210 that is highlighted does not include the current time, the set-top box device 102 may retrieve information from one or more sources (e.g., a service provider network, a broadcast source, or other information source related to the media content) to be displayed in the media content preview window 204. When no information for the media content corresponding to the entry 210 is available from the one or more sources, a channel logo for a channel that corresponds to the entry 210 or other content may be displayed in the media content preview window 204. When information related to the media content corresponding to the entry 210 is retrieved from the one or more sources, the information may be displayed in the media content preview window 204. The information may include, but is not limited to, a preview clip of the media content, a still image corresponding to the media content, information regarding the media content to be shown during the time entry range, or combinations thereof.

Each entry 210 of the EPG table 208 may display information related to a program that is to be shown on the channel corresponding to the row during the time period corresponding to the column. The information may include the name of the program. Additional information for a particular entry may be presented when the particular entry is highlighted or otherwise selected. The additional information may include, but is not limited to, an episode title when the program is a serial program, special guest stars in the program when the program is a serial program, actors in the program, director of the program, information related to the content of the program, and combinations thereof.

The additional media content window 206 may include one or more selectable entries 212-218. Selection of a particular selectable entry of the selectable entries 212-218 by the user using the remote control device 122 may cause the set-top box device 102 to send a graphical user interface (GUI) to the display device 112. The GUI may show media content that is available from the particular selectable entry. For example, selection of the On-demand Media Content selectable entry 212 may cause the set-top box device 102 to present a GUI that allows the user to search and select media content available via a public network from a catalog of content available from a service provider that provides access to the public network for the user. Selection of the STB Device Content selectable entry 214 may cause the set-top box 102 to present a GUI that allows the user to select media content for display from a digital locker of the set-top box device 102. The media content may be rented media content, purchased media content, or personal media content (e.g., personal videos and photograph slideshows). Selection of the Third Party On-demand Media Content selectable entry 216 may cause the set-top box device 102 to present a GUI that allows the user to search and select media content for rent or purchase from a catalog of a third party on-demand media content service. Selection of the Computer System Media Content selectable entry 218 may cause the set-top box device 102 to present a GUI that displays media content available from a computer system coupled to the set-top box device 102 by a LAN or other network connection. When the computer system is not coupled to the set-top box device 102, the Computer System Media Content selectable entry 218 may not appear or may not be selectable. The titles for the selectable entries 212-218 are representative and other titles may be chosen. When the additional media content window 206 includes additional selectable entries, the additional selectable entries may be accessed using a down key and an up key of the remote control device 122. A position in a listing of all the selectable entries 212-218 in the additional media content window 206 may be indicated by an indicator 220 of a scroll bar 222.

The EPG table 208 may present media content items available as OTA television content items and on-demand media content items provided from the service provider network in a single location. A first entry 224 in the EPG table 208 may indicate that a first row of the EPG table 208 displays time ranges and a first column of the EPG table 208 displays channels. Times indicated in the time ranges in the first row may correspond to times when display of media content typically starts or ends. Additional time ranges may be viewed by navigating to the right or left in the EPG table 208 using right and left keys of the remote control device 122. The entry 210 that is currently selected may be highlighted or indicated by some other visual distinction from other entries 210. A general position of a selected entry relative to the possible time range entries in the EPG table 208 may be indicated by an indicator 226 in a scroll bar 228. When the user has selected an entry 210 in the EPG table 208 corresponding to a time range that does not include the current time, the user may switch to the entry 210 in the same row with a time range that includes the current time by using the right and the left keys of the remote control device 122 or by pressing the home key of the remote control device 122.

The channels presented in the first column of the EPG table 208 may include OTA channels 230 that one or more tuners of the set-top box device 102 are able to identify and tune. Names of the channels 230 may correspond to names of networks that provide the OTA content for the channels 230. The OTA channels 230 may include standard definition (SD) channels and high definition (HD) channels. Two OTA channels 230 are depicted in FIG. 2, but fewer or more OTA channels 230 may be available to the set-top box device 102. The channels presented in the first column of the EPG table 208 may include channels 232 from the service provider network via the public network. Names of the channels 232 may correspond to names of networks that provide content for the channels 232. The channels may include indications that inform the user whether the content of the channels 232 is presented in a standard definition (SD) format or a high definition (HD) format. Two channels 232 from the service provider network via the public network are depicted in FIG. 2, but fewer or more channels 232 from the service provider network via the public network may be available to the set-top box device 102. Additional OTA channels 230 and additional channels 232 from the service provider network via the public network available to the set-top box device 102 may be viewed by navigating up and down in the EPG table 208 using the remote control device 122. A general position of a selected entry relative to the possible channels in the EPG table 208 may be indicated by an indicator 234 in a scroll bar 236.

The user may request the EPG 200 by pressing an EPG key on the remote control device 122. The EPG 200 presented by the set-top box device 102 may highlight the entry 210 in the EPG table 208 that corresponds to the current time and the present selected channel. The media content preview window 204 may display the media content that was displayed on the display device 112 prior to receipt of the request for the EPG 200. The user may navigate to another entry 210 or to another window of the EPG 200 using the keys of the remote control device 122. When the user moves to a different entry in the EPG table 208, the different entry is highlighted and the display presented in the media content preview window 204 may change. The user may choose to view the media content corresponding to the different entry by pressing a play key of the remote control device 122. The user may choose to schedule the different entry for recording by pressing a record key of the remote control device 122. The user may exit the EPG 200 by navigating to a return button 238 of the EPG 200 or by pressing a return key of the remote control device 122.

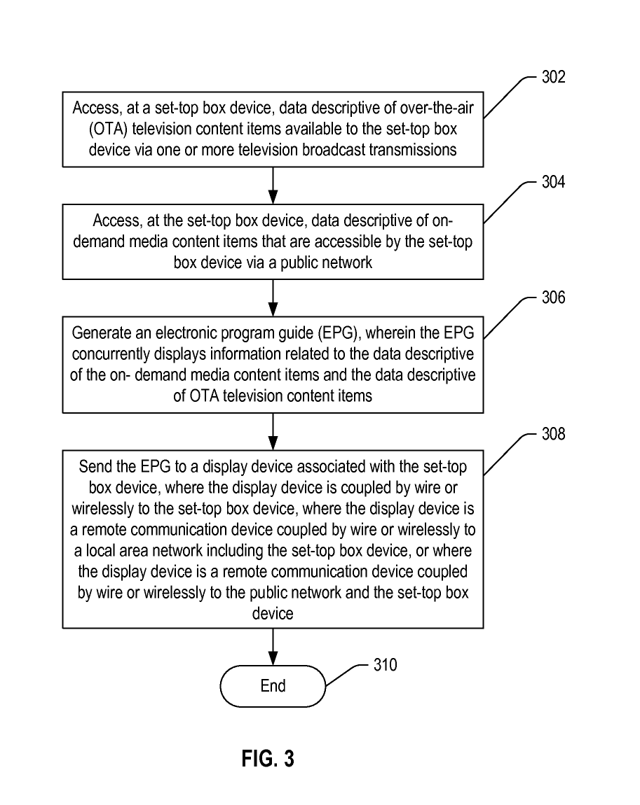

Referring to FIG. 3, a particular embodiment of a method to generate an electronic program guide is illustrated. The method includes, at 302, accessing data descriptive of over-the-air (OTA) television content items. The OTA television content items may be available to the set-top box device via one or more television broadcast transmissions (e.g., OTA television content items received from the OTA transmitters 110 depicted in FIG. 1). The data may be accessed at a set-top box device (e.g., the set-top box device 102 depicted in FIG. 1). The data may be obtained from broadcast stations providing the broadcast transmissions, service providers, other sources, or combinations thereof. The data may include a start time and an end time for OTA television content items.

The method includes, at 304, accessing data descriptive of on-demand media content items that are accessible by the set-top box device via a public network (e.g., the set-top box 102 and the public network 106 depicted in FIG. 1). The data may be a base EPG provided by the service provider that provides access to the public network.

At 306, an EPG may be generated. The EPG may include the base EPG with additional information related to available OTA television content items added to the base EPG to produce the EPG. The EPG may concurrently display the data descriptive of the on-demand media content items and the data descriptive of the OTA television content items.

At 308, the EPG may be sent to a display device associated with the set-top box device. In an embodiment, the display device may be coupled by wire or wirelessly to the set-top box device. In an embodiment, the display device may be a remote communication device coupled by wire or wirelessly to a LAN that is coupled to the set-top box device. In a further embodiment, the display device may be a remote communication device coupled by wire or wirelessly to the public network and to the set-top box device. The method ends, at 310.

The method allows for the retrieval of data descriptive of both OTA television content items available to the user and on-demand media content items from the service provider and available to the user. The data descriptive of OTA television content items and the data descriptive of the on-demand media content items may be incorporated in a single EPG that the user may use to determine what to view at a particular time.

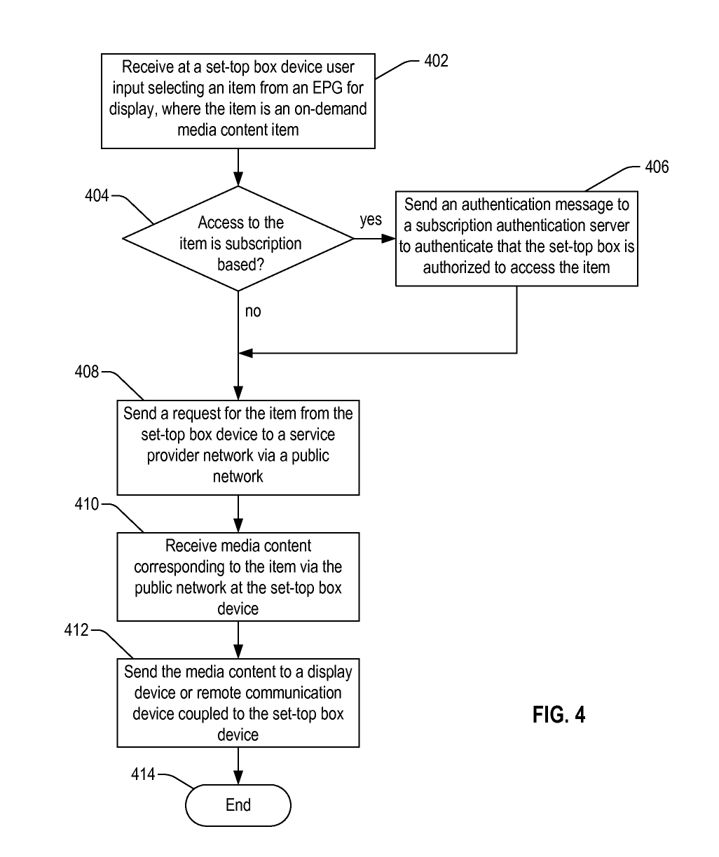

Referring to FIG. 4, a particular embodiment of a method for using a generated EPG when a set-top box device receives user input selecting an on-demand media content item from the EPG (e.g., the EPG 200 depicted in FIG. 2) for display on a display device or remote communication device (e.g., the set-top box device 102, the display device 112, the computer system 116, the PMP 118, or the communication device 120 depicted in FIG. 1) is illustrated. The method includes, at 402, receiving at the set-top box device user input selecting an item from an EPG for display, where the item is an on-demand media content item.

At 404, a determination of whether access to the item is subscription-based is made. When the item is a subscription-based item, an authentication message to a subscription authentication service is sent to authenticate that the set-top box device is authorized to access the item, at 406. When the request is authenticated, the method may continue, at 408.

When the determination, at 404, indicates that access to the item is not subscription-based, the method may proceed to 408. At 408, a request for the item may be sent from the set-top box device to a service provider network via a public network. Since the request and the item are to be transmitted via the public network, a system coupled to the content source may verify that the request is coming from a source with rights to access the content source. After the rights to access the content source are verified, the set-top box device may receive media content corresponding to the item via the public network, at 410.

The media content may be sent to the display device or to the remote communication device selected to receive the on-demand media content item, at 412. The on-demand content item may be streamed, progressively downloaded, or fully downloaded to the set-top box device depending on the availability of the on-demand media content item and the desire of the user. When the on-demand media content item is streamed, the on-demand media content item is delivered in small units and is buffered in the set-top box device memory for playback to a display device coupled to the set-top box device. The buffered content is not retained in the memory. After the on-demand media content item has been streamed and sent to the display device, the on-demand media content item does not remain in the memory of the set-top box device for subsequent playback.

When the on-demand media content item is progressively streamed to the set-top box device, the on-demand media content item is delivered in small units and is committed to memory. The entire on-demand media content item does not have to be delivered before playback is allowed. Playback of the on-demand media content item to the display device is allowed once there is an estimated sufficient portion of the content delivered to allow the on-demand media content item to be played without having to interrupt the playback to retrieve an additional portion of the on-demand media content item. The on-demand media content item may remain in the memory until removed by the user, until the on-demand media content item is viewed, or until a license for the on-demand media content item expires.

When the on-demand media content item is to be fully downloaded, the on-demand media content item is delivered in small units and is committed to memory, but playback of the on-demand media content item to the display device is not enabled until all of the on-demand media content item is delivered to the set-top box device. The on-demand media content item may remain in the memory until removed by the user, until the on-demand media content item is viewed, or until a license for the on-demand media content item expires.

The method may end at 414. The method allows the user to retrieve on-demand media content items selected from the EPG. The EPG presents media content items available as OTA television content items and on-demand media content items.

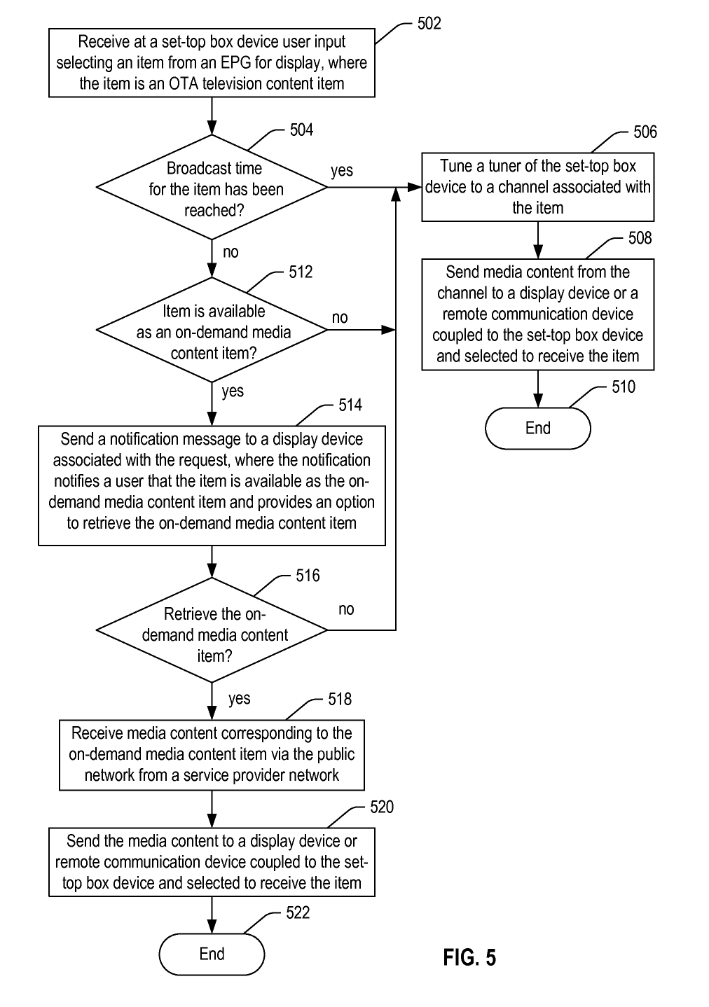

Referring to FIG. 5, a particular embodiment of a method for using a generated EPG (e.g., the EPG 200 of FIG. 2) when a set-top box device receives user input selecting an OTA television content item from the EPG for display on a display device or remote communication device (e.g., the set-top box device 102, the display device 112, the computer system 116, the PMP 118, or the communication device 120 depicted in FIG. 1) is illustrated. The method includes, at 502, receiving at the set-top box device user input selecting an item from an EPG for display, where the item is an OTA television content item.

At 504, a determination of whether a broadcast time for the item has been reached may be made. When the broadcast time has been reached, a tuner of the set-top box device may be tuned to a channel associated with the item, at 506. The media content from the channel may be sent to the display device or the remote communication device, at 508. The method may then end at 510.

When the determination, at 504, indicates that the broadcast time has not been reached, a determination of whether the item is available as an on-demand content item may be made, at 512. Content of an on-demand service provided by the service provider, content of one or more third party on-demand services, or both may be searched to make the determination. When the item is not available as an on-demand content item at 512, the method may continue, at 506, where the tuner of the set-top box device tunes to the channel associated with the item. The media content from the channel may be sent to the display device or to the remote communication device coupled to the set-top box device and selected to receive the item, at 508. The method ends, at 510.

When the determination at 512 indicates that the item is available as an on-demand media content item, a notification message may be sent to a display device associated with the request, at 514. The notification may notify a user that the item is available as the on-demand media content item and provide an option to retrieve the on-demand media content item.

A determination may be made whether to retrieve the on-demand media content item, at 516. The determination may be made by receiving a response from the user explicitly stating the user preference or by passage of a certain amount of time, which may be taken to indicate that the user does not desire to retrieve the on-demand media content item. When the determination, at 516, indicates that the user does not desire to retrieve the on-demand media content item, the method may continue at, 506, where the tuner of the set-top box device tunes to the channel associated with the item. The OTA television content from the channel may be sent to the display device or to the remote communication device coupled to the set-top box device and selected to receive the item, at 508. The method ends, at 510.

When the determination, at 516, indicates that the user does desire to retrieve the on-demand media content item, media content corresponding to the on-demand media content item may be received via the public network from a service provider network, at 518. The media content may be sent to the display device or to remote communication device coupled to the set-top box device and selected to receive the item. The on-demand media content item may be streamed, may be progressively downloaded, or may be fully downloaded to the set-top box device depending on the availability of the on-demand media content item and the desire of the user. The method ends, at 522.

The method allows the user to retrieve OTA television content items selected from the EPG. The EPG presents media content items available as OTA television content items and as on-demand media content items. When the selected item is an OTA television content item that is available as an on-demand media content item, the method provides the user with an option to retrieve the selected media content item as the on-demand media content item instead of as the OTA television content item.

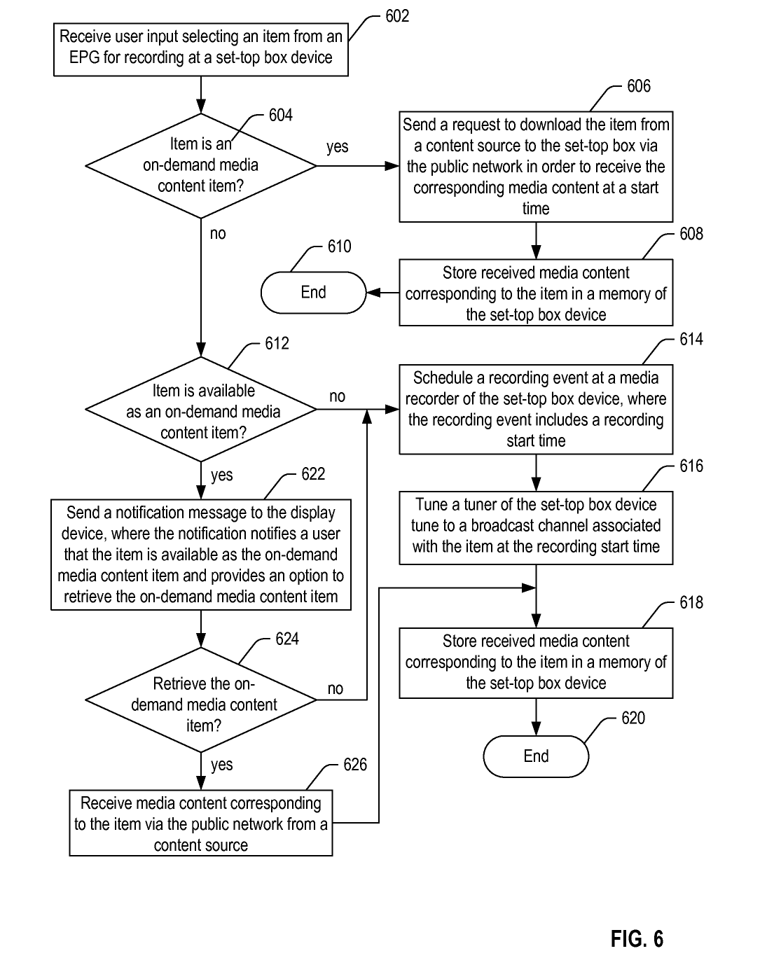

Referring to FIG. 6, a particular embodiment of a method for using a generated EPG (e.g., the EPG 200 of FIG. 2) when a set-top box device (e.g., the set-top box device 102 of FIG. 1) receives user input selecting an item from an EPG for recording. The user input may be received from a remote control device (e.g., the remote control device 122 depicted in FIGS. 1 and 2), from the set-top box device, or both. The user input may be received from a remote communication device coupled to the set-top box device via a LAN or via a public network (e.g., the computer system 116, the PMP 118, or the communication device 120 depicted in FIG. 1). The method may include, at 602, receiving user input selecting an item from the EPG for recording at the set-top box device.

A determination of whether the item is an on-demand media content item is made, at 604. When the item is an on-demand media content item, a request to download the item from a service provider network to the set-top box device via the public network is sent, at 606. The request is sent so the media content corresponding to the item is received at a start time for the item. Media content corresponding to the item may be received at the set-top box device, at 608. The on-demand media content item may be streamed, may be progressively downloaded, or may be fully downloaded to the set-top box device depending on the availability of the on-demand media content item and the desire of the user. The method ends, at 610.

When the determination, at 604, indicates that the item is not an on-demand media content item, a determination of whether the item is available as an on-demand media content item may be made, at 612. Content of an on-demand service provided by the service provider, content of one or more third party on-demand services, or both, may be searched to make the determination of whether the item is available as an on-demand media content item. When the item is not available as an on-demand media content item, a recording event at a media recorder of the set-top box device may be scheduled, at 614. The recording event may include a recording start time and a recording end time. A tuner of the set-top box device may be tuned to a broadcast channel associated with the item at the recording start time, at 616. Received media content corresponding to the item may be stored in a memory of the set-top box device, at 618. The method ends, at 620.

When the determination at 612 indicates that the item is available as an on-demand media content item, a notification may be sent to a display device associated with the input selecting the item for recording, at 622. The notification may notify a user that the item is available as the on-demand media content item and may provide an option to retrieve the on-demand media content item.

A determination may be made at 624 whether to retrieve the on-demand media content item. The determination may be made by receiving a response from the user explicitly stating the user preference, or by passage of a certain amount of time which may be taken to indicate that the user does not desire to retrieve the on-demand media content item. When the determination at 624 indicates that the user does not desire to retrieve the on-demand media content item, the method may continue at 614 where a recording event at a media recorder of the set-top box device may be scheduled. The recording event may include a recording start time and a recording end time. A tuner of the set-top box device may be tuned to a broadcast channel associated with the item at the recording start time, at 616. Received media content corresponding to the item may be stored in a memory of the set-top box device, at 618. The method ends, at 620.

When the determination at 624 indicates that the user does desire to retrieve the on-demand media content item, media content corresponding to the item may be received via the public network from a source (e.g., the service provider network or the third party on-demand service), at 626. The on-demand media content item may be streamed, may be progressively downloaded, or may be fully downloaded to the set-top box device depending on the availability of the on-demand media content item and the desire of the user. The method may then end at 620.

The method allows the user to select an item from the EPG for recording. The item may be an OTA television content item or an on-demand media content item. When the selected item is an OTA television content item that is available as an on-demand media content item, the method provides the user with an option to retrieve the selected media content item as the on-demand media content item instead of as the OTA television content item, to record the selected media content item as the on-demand media content item, or both, instead of recording the item when the item is received from an OTA transmitter.

Embodiments disclosed herein may provide cost effective and efficient ways for a service provider to provide on-demand media content and television content to customers without the need to establish and maintain a private network infrastructure for delivering the on-demand media content and the television content. Embodiments disclosed herein may be readily implemented because the public network already exists and because broadcasts of OTA television content are available. The embodiments disclosed herein may include set-top box device that provide customers with media content available at particular times, where the media content may be obtained as OTA television content received via an antenna or on-demand media content from a service provider network received via a public network. The EPG may also provide access to other sources of available media content.

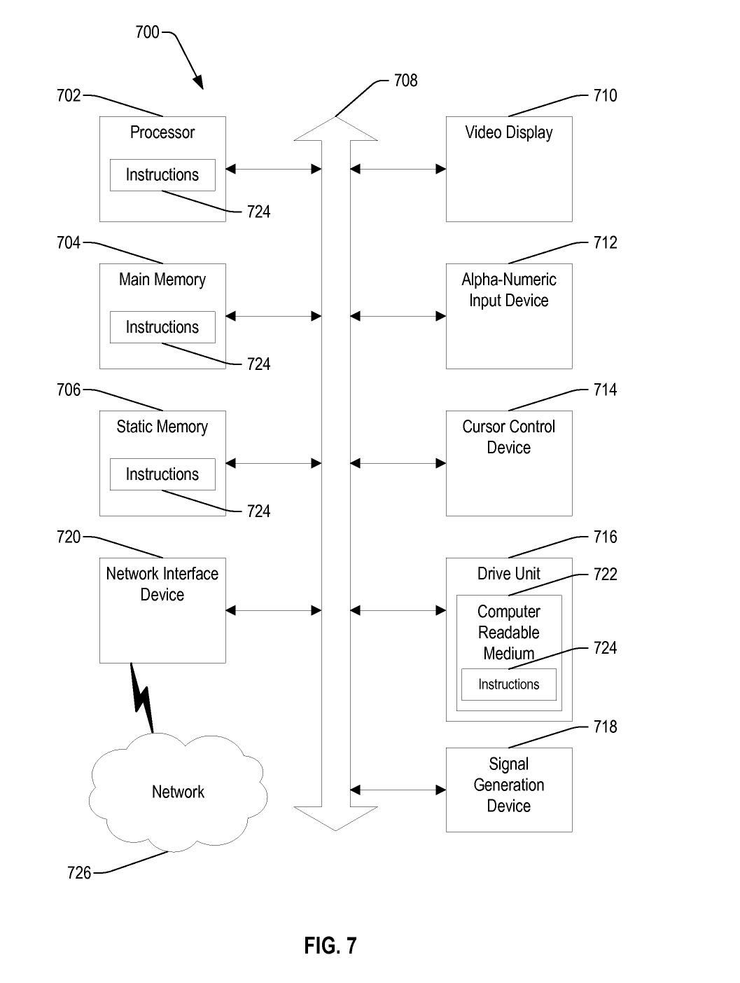

Referring to FIG. 7, an illustrative embodiment of a general computer system is shown and is designated 700. The computer system 700 may include a set of instructions that can be executed to cause the computer system 700 to perform any one or more of the methods or computer based functions disclosed herein. The computer system 700 may operate as a standalone device or may be connected, e.g., using a network, to other computer systems or peripheral devices. For example, the computer system 700 may include or be included within any one or more of the set-top box device 102, the service provider network 104, the display device 112, the computer system 116, the personal media player 118, the communication device 120, the remote control device 122, the intake servers 154, the firewalls 158, the EPG servers 160, and the authentication server 162 described with reference to FIG. 1.

In a networked deployment, the computer system 700 may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB) device, a personal digital assistant (PDA), a mobile device, a palmtop computer, a laptop computer, a desktop computer, a communications device, a wireless telephone, a land-line telephone, a control system, a web appliance, or any other machine capable of executing a set of instructions (sequential or otherwise) that specify actions to be taken by that machine. In a particular embodiment, the computer system 700 may be implemented using electronic devices that provide video, audio, or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 may include a main memory 704 and a static memory 706, which can communicate with each other via a bus 708. As shown, the computer system 700 may further include a video display unit 710, such as a liquid crystal display (LCD), a projection television system, a flat panel display, or a solid state display. Additionally, the computer system 700 may include an input device 712, such as a keyboard, and a cursor control device 714, such as a mouse. The computer system 700 may also include a disk drive unit 716, a signal generation device 718, such as a speaker or remote control, and a network interface device 720. Some computer systems 700 may not include an input device (e.g., a server may not include an input device).

In a particular embodiment, as depicted in FIG. 7, the disk drive unit 716 may include a computer-readable storage medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a computer-readable storage medium that stores instructions 724 or receives, stores and executes instructions 724 responsive to a propagated signal, so that a device connected to a network 726 may communicate voice, video or data over the network 726. Further, the instructions 724 may be transmitted or received over the network 726 via the network interface device 720.

While the computer-readable storage medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable storage medium may include a solid-state memory such as a memory card or other package that houses one or more non-volatile read-only memories. Further, the computer-readable storage medium may be a random access memory or other volatile re-writable memory. Additionally, the computer-readable storage medium may include a magneto-optical or optical medium, such as a disk or tapes or other storage device. A digital file attachment to an e-mail or other self-contained information archive or set of archives may be considered equivalent to a tangible storage medium. Accordingly, the disclosure is considered to include any one or more of a computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A set-top box device, comprising:
a memory device;
a network interface configured to receive on-demand media content items via a public network;
one or more video tuners configured to receive over-the-air (OTA) television content items via one or more television broadcast transmissions;
an electronic program guide (EPG) module configured to generate an EPG that concurrently displays information descriptive of the on-demand media content items that are available via the public network and information descriptive of the OTA television content items available via the one or more television broadcast transmissions; and
a video recording module configured to selectively record the OTA television content items to the memory device.

2. The set-top box device of claim 1, wherein the set-top box device is configured to receive from the public network high definition (HD) video content or standard definition (SD) video content, wherein the set-top box device is configured to receive from one or more broadcast transmitters HD television content or SD television content, wherein media content stored in a digital locker of the memory device is sendable to a display device coupled to the set-top box device, wherein the media content stored in the digital locker is sendable to an external communication device coupled to the set-top box device via the public network or a local area network, wherein the set-top box device is configured to access an application server via the public network to provide one or more applications to the display device, and wherein the set-top box device is configured to access the external communication device to provide media content from the external device to the display device.

3. The set-top box device of claim 1, further comprising a processor configured to process media content received via the network interface and the OTA television content from the one or more video tuners.

4. The set-top box device of claim 1, wherein an EPG server sends a base EPG over the public network, and wherein the EPG module modifies the base EPG to produce the EPG.

5. The set-top box device of claim 1, wherein the EPG further concurrently displays data descriptive of local content stored at the memory device.

6. The set-top box device of claim 5, wherein the local content comprises one or more of rented media content, purchased media content, and personal media content.

7. The set-top box device of claim 1, wherein the EPG further concurrently displays information descriptive of subscription-based content available via the public network.

8. The set-top box device of claim 1, further comprising an antenna coupler to couple the one or more video tuners to an antenna to receive the one or more television broadcast transmissions.

9. The set-top box device of claim 1, wherein the network interface is further configured to receive and send information from one or more devices via a local area network (LAN).

10. The set-top box device of claim 9, wherein the EPG further concurrently displays information descriptive of multimedia content available from the one or more devices of the LAN.

11. A method, comprising:
accessing, at a set-top box device, data descriptive of over-the-air (OTA) television content items, wherein the OTA television content items are available to the set-top box device via one or more television broadcast transmissions;
accessing, at the set-top box device, data descriptive of on-demand media content items that are accessible by the set-top box device via a public network;
generating an electronic program guide (EPG), wherein the EPG concurrently displays information related to the data descriptive of on-demand media content items and the data descriptive of the OTA television content items; and
sending the EPG to a display device associated with the set-top box device.

12. The method of claim 11, further comprising:
receiving user input selecting an item from the EPG for display;
determining whether the selected item is one of the on-demand media content items or one of the OTA television content items;
when the selected item is one of the on-demand media content items, sending a request for the selected item from the set-top box device to a service provider network via the public network; and
when the selected item is one of the OTA television content items, tuning a tuner of the set-top box device to a channel associated with the selected item.

13. The method of claim 12, wherein when the selected item is one of the OTA television content items and a broadcast time of the selected item has not been reached:
determining whether the selected item is available as one of the on-demand media content items; and
when the selected item is available as one of the on-demand media content items, sending a notification message to the display device, wherein the notification message indicates that the selected item is available as one of the on-demand media content items.

14. The method of claim 11, further comprising:
receiving user input selecting an item from the EPG for recording;
determining whether the selected item is one of the on-demand media content items or one of the OTA television content items; and
when the selected item is one of the on-demand media content items, sending a request to download the selected item from a content source to the set-top box device via the public network.

15. The method of claim 14, further comprising, when the selected item is one of the OTA television content items:
scheduling a recording event at a media recorder of the set-top box device, wherein the recording event includes a recording start time; and
tuning a tuner of the set-top box device to a broadcast channel associated with the selected item at the recording start time.

16. The method of claim 14, further comprising, when the selected item is one of the OTA television content items:
determining whether the selected item is available as one of the on-demand media content items; and
when the selected item is available as one of the on-demand media content items, sending a notification message to the display device, wherein the notification message indicates that the selected item is available as one of the on-demand media content items.

17. The method of claim 11, further comprising:
receiving user input selecting an on-demand media content item from the EPG for display;
determining whether access to the on-demand media content item is subscription-based; and
when access to the selected item is subscription-based, sending an authentication message to a subscription authentication server to authenticate that the set-top box is authorized to access the selected item.

18. The method of claim 11, wherein sending the EPG to a display device associated with the set-top box device comprises sending the EPG to a remote communication device via the public network.

19. A set-top box device, comprising:
at least one processor; and
at least one memory accessible to the at least one processor, the at least one memory comprising:
instructions executable by the at least one processor to determine one or more available over-the-air channels (OTA);
instructions executable by the at least one processor to access data descriptive of OTA channel content items for the one or more available OTA channels for a particular time period;
instructions executable by the at least one processor to access data descriptive of on-demand media content items that are accessible via a public network;
instructions executable by the at least one processor to generate an electronic program guide (EPG), wherein the EPG concurrently displays information related to the on-demand media content items and the OTA television content items for the particular time period; and
instructions executable by the at least one processor to send the EPG to a display device.

20. The set-top box device of claim 19, wherein the display device is a personal media player.
